(19) United States
(12) Patent Application Publication
(10) Pub. No.: US 2017/0045466 A1
(43) Pub. Date: Feb. 16, 2017

(54) SENSOR UNIT FOR THERMAL ANALYSIS EQUIPMENT AND THERMAL ANALYSIS EQUIPMENT

(71) Applicant: RIGAKU CORPORATION, Tokyo (JP)

(72) Inventor: Koichiro Noritake, Tokyo (JP)

(73) Assignee: RIGAKU CORPORATION, Tokyo (JP)

(21) Appl. No.: 15/233,380

(22) Filed: Aug. 10, 2016

(30) Foreign Application Priority Data
Aug. 12, 2015 (JP) 2015-159367

(51) Int. Cl. G01N 25/48

(52) U.S. Cl. CPC G01N 25/4866; G01N 25/486

(57) ABSTRACT

First and second multi-pair thermocouples (21, 22) are formed on the upper surface of a heat-sensitive member (10), and a thermally uniformizing member (30) is adhesively attached to a base portion (11) of the heat-sensitive member (10). The thermally uniformizing member (30) is formed of a heat-resistant and electrically insulating material having a higher thermal conductivity than the heat-sensitive member (10) and a linear expansion coefficient approximate to the linear expansion coefficient of the heat-sensitive member (10). For example, the heat-sensitive member (10) is formed of mullite, and the thermally uniformizing member (30) is formed of aluminum nitride, whereby damage caused by thermal expansion can be prevented and at the same time the base portion (11) of the heat-sensitive member (10) can be thermally uniformalized.

### FIELD OF THE INVENTION

The present invention relates to thermal analysis equipment for detecting the temperature difference between a measurement sample and a reference sample, and a sensor unit installed in the same.

### BACKGROUND OF THE INVENTION

A temperature difference sensor having a pair of thermocouples has been conventionally used for thermal analysis equipment such as DTA (Differential Thermal Analyzer) DSC (Differential Scanning calorimeter) or the like. Such a temperature difference sensor detects the temperature of a measurement sample and the temperature of a reference sample by the respective thermocouples, and outputs the temperature difference between the measurement sample and the reference sample.

Furthermore there has been recently proposed a temperature difference sensor which is configured to detect each of the temperature of a measurement sample and the temperature of a reference sample by using a thermocouple called as a multi-pair thermocouple to enhance temperature measuring sensitivity (see Patent Document 1). The multi-pair thermocouple is a thermocouple which is configured so that two kinds of different metal materials are alternately joined to each other, and plural temperature measurement contact points and plural reference contact points are alternately formed at the joint portions (junction portions).

This multi-pair thermocouple is configured so that the plural thermocouples are connected to one another in series, and the sum of electromotive forces output from the respective thermocouples is output in connection with the temperature difference between the temperature measurement contact point and the reference contact point. Therefore, the multi-pair thermocouple has a feature that the sensitivity of temperature measurement is enhanced because a large electromotive force is generated for a small temperature difference.

Here, the Patent Document 1 discloses a sample holder (that is, sensor unit) using the multi-pair thermocouple. According to the sample holder disclosed in the patent document 1, a multi-pair thermocouple is arranged around each of the sample position and the reference position, and the temperature difference between a sample material disposed at the sample position and a reference material disposed at the reference position is detected on the basis of signals (electromotive forces) from the respective multi-pair thermocouples.

The multi-pair thermocouple has plural temperature measurement contact points and plural reference contact points. Therefore, even when there is slight temperature dispersion among sites where these contact points (that is junction points) are arranged, dispersion also occurs among the electromotive forces from the respective thermocouples constituting the multi-pair thermocouple.

Particularly, the plural reference contact points are arranged on circumferences away from the sample position and the reference position, and thus the locations thereof are far away from one another. Therefore, dispersion in temperature is liable to occur among the sites at which the respective reference contact points are located, and the temperature dispersion amounts of the respective sites are superimposed, resulting in a risk that the temperature measurement precision is reduced.

### PRIOR ART DOCUMENTS

[Patent Document 1] U.S. Pat. No. 6,935,776

[Patent Document 2] WO2014/153438

### SUMMARY OF THE INVENTION

The present invention has been implemented in view of the foregoing situation, and has an object to suppress dispersion of electromotive forces occurring in individual thermocouples constituting a multi-pair thermocouple and thus enhance the temperature measurement precision by thermally uniformizing the temperature of a base portion at which reference contact points of the multi-pair thermocouples are arranged.

In order to attain the above object, according to the present invention, there is provided a sensor unit for thermal analysis equipment for detecting the temperature difference between a measurement sample and a reference sample, comprising: a heat-sensitive member having a measurement sample arrangement portion where the measurement sample is disposed, a reference sample arrangement portion where the reference sample is disposed, and a base portion that is set to be located away from the measurement sample arrangement portion and the reference sample arrangement portion; a first multi-pair thermocouple in which two kinds of different metal materials are alternately joined to one another to alternately form plural temperature measurement contact points and plural reference contact points so that the plural temperature measurement contact points are arranged at the measurement sample arrangement portion and the plural reference contact points are arranged at the base portion; a second multi-pair thermocouple in which two kinds of different metal materials are alternately joined to one another to alternately form plural temperature measurement contact points and plural reference contact points so that the plural temperature measurement contact points are arranged at the reference sample arrangement portion and the plural reference contact points are arranged at the base portion; and a thermally uniformizing member that is adhesively attached to the base portion, wherein the thermally uniformizing member is formed of a heat-resistant and electrically insulating material that has a higher thermal conductivity than the heat-sensitive member and a linear expansion coefficient approximate to that of the heat-sensitive member.

Since the thermal conductivity of the heat-sensitive member is suppressed to a certain magnitude because temperature variation caused by physicality variation of the measurement sample is required to occur at least between the measurement sample arrangement portion and the base portion. Accordingly, the temperature is liable to be non-uniform at some places in the base portion of the heat-sensitive member. Therefore, according to the present invention, the thermally uniformizing member having a high thermal conductivity is adhesively attached to the base portion of the heat-sensitive member, and the temperature of the base portion in the heat-sensitive member is made to be uniform through the thermally uniformizing member, whereby the dispersion of electromotive force occurring in each individual thermocouple constituting the multi-pair thermocouple can be suppressed and the temperature measurement precision can be enhanced.

However, when the linear expansion coefficient is greatly different between the heat-sensitive member and the thermally uniformizing member in the construction that the thermally uniformizing member is adhesively attached to the base portion of the heat-sensitive member, the degree of thermal expansion caused by heating is different between the members, so that stress may occur between the members, resulting in damage of these members.

Therefore, according to the present invention, the linear expansion coefficient of the thermally uniformizing member is set to be approximate to that of the heat-sensitive member, thereby preventing the damage caused by the stress occurring between the members as described above.

In general, when the difference in linear expansion coefficient between the attached members is made to fall within 1×10⁻⁶/° C., expansion difference which may damage the members does not occur between the members even when the members are heated to high temperature.

The inventor of this application has considered various combinations of ceramic materials, and consequently has achieved excellent thermal uniformity of the base portion and uniform thermal expansion between the members by forming the heat-sensitive member of mullite and forming the thermally uniformizing member of aluminum nitride.

Furthermore, according to the present invention, the sensor unit may be provided with base temperature measuring means for measuring the temperature of the base portion in the heat-sensitive member. The base temperature measuring means may comprise a sheathed thermocouple, for example. By measuring the temperature of the base portion with the base temperature measuring means, the temperature difference between the base portion and the measurement sample arrangement portion that is detected by the first multi-pair thermocouple is added to the temperature of the base portion, whereby the temperature of the measurement sample arrangement portion (that is, the measurement sample) can be accurately determined.

The thus-configured sensor unit of the present invention can be manufactured by forming the heat -sensitive member like a flat plate, screen-printing the first and second multi-pair thermocouples on the heat-sensitive member, and adhesively attaching the flat-plate type thermally uniformizing member to the heat-sensitive member through glass paste. Here, when the thermally uniformizing member is adhesively attached to each of the front and back surfaces of the heat-sensitive member, the base portion of the heat-sensitive member can be more rapidly thermally uniformalized.

According to the present invention, the temperature of the base portion in which the reference contact points of the multi-pair thermocouple are arranged can be made uniform to suppress dispersion of electromotive forces occurring in the individual thermocouples constituting the multi-pair thermocouple, thereby enhancing the temperature measurement precision.

### BRIEF DESCRIPTION OF THE DRAWINGS

FIG. 1 is a schematic diagram showing the structure of thermal analysis equipment according to an embodiment of the present invention;

FIG. 2 is a perspective view showing the overall construction of a sensor unit for the thermal analysis equipment according to the embodiment of the present invention;

FIG. 3 is a plan view showing the upper surface of the sensor unit for the thermal analysis equipment according to the embodiment of the present invention;

FIG. 4 is a plan view showing the shape of a multi-pair thermocouple provided to a heat-sensitive member of the sensor unit for the thermal analysis equipment according to the embodiment of the present invention;

FIG. 5 is a graph showing the linear expansion coefficients of various kinds of ceramics;

FIGS. 6A and 6B are diagrams showing a method of achieving sample temperature by the sensor unit for the thermal analysis equipment according to the embodiment of the present invention;

FIG. 7 is a perspective view showing a manufacturing step of the sensor unit for the thermal analysis equipment according to the embodiment of the present invention;

FIG. 8 is a perspective view showing a manufacturing step subsequent to FIG. 7 of the sensor unit for the thermal analysis equipment according to the embodiment of the present invention;

FIG. 9 is a perspective view showing a manufacturing step subsequent to FIG. 8 of the sensor unit for the thermal analysis equipment according to the embodiment of the present invention; and

FIG. 10 is a perspective view showing a manufacturing step subsequent to FIG. 9 of the sensor unit for the thermal analysis equipment according to the embodiment of the present invention.

### DETAILED DESCRIPTION OF EMBODIMENTS

An embodiment according to the present invention will be described hereunder with reference to the accompanying drawings.

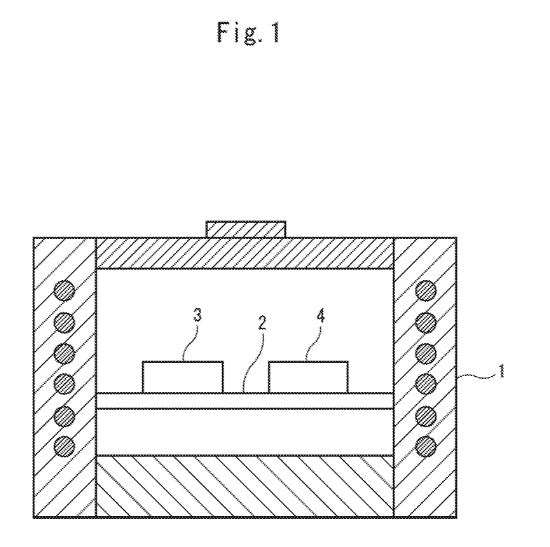

FIG. 1 is a schematic diagram showing the structure of thermal analysis equipment according to an embodiment of the present invention.

The thermal analysis equipment shown in FIG. 1 is also referred to as DSC (Differential Scanning Calorimeter), and has a function of measuring the temperature difference between a measurement sample and a reference sample as a function of temperature or time while changing the temperature of the measurement sample and the reference sample according to a certain temperature program.

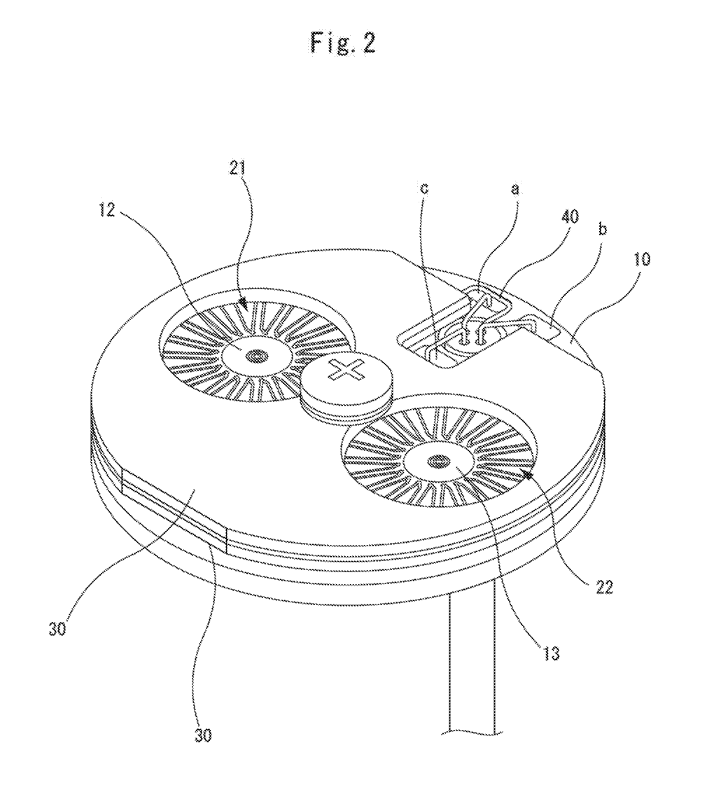

The thermal analysis equipment shown in FIG. 1 is configured so that a sensor unit 2 is disposed in a heating furnace 1, and a measurement sample container 3 and a reference sample container 4 are arranged on the upper surface of the sensor unit 2. The measurement sample in the measurement sample container 3 and the reference sample in the reference sample container 4 are heated and increased in temperature under the same condition. by the heating furnace 1, and the temperature difference between the measurement sample and the reference sample is detected by thermocouples equipped to the sensor unit 2. The sensor unit 2 will be described later in detail with reference to FIG. 2, etc.

As not shown in FIG. 1 the thermal analysis equipment is provided with circuits for performing control of respective components and measurement analysis of temperature such as a temperature control circuit for the heating furnace 1, a temperature difference detection circuit for determining the temperature difference from electromotive forces output from thermocouples, etc.

FIGS. 2 to 4 show the configuration of the sensor unit 2 for the thermal analysis equipment according to the embodiment of the present invention.

As shown in FIG. 2 the sensor unit 2 is configured so that first and second multi-pair thermocouples 21, 22 are provided on the upper surface of a heat-sensitive member 10, and thermally uniformizing members 30 are adhesively attached to a base portion 11 of the heat-sensitive member 10 from the upper surface (front surface) and the bottom surface (back surface) thereof.

The heat-sensitive member 10 is formed like a disc, and a measurement sample arrangement portion 12 and a reference sample arrangement portion 13 are set in the form of a circular area on the upper surface of the heat-sensitive member 10. A measurement sample container 3 is disposed at the measurement sample arrangement portion 12, and a reference sample container 4 is disposed at the reference sample arrangement portion 13. As shown in FIG. 1, the heat sensitive member 10 is disposed concentrically in the heating furnace 1, and the measurement sample arrangement portion 12 and the reference sample arrangement portion 13 are positioned to be laterally symmetrical with each other with respect to the center of the heat-sensitive member 10, whereby a measurement sample and a reference sample in the respective sample containers 3 and 4 arranged on the arrangement portions 12 and 13 are heated under the same condition in the heating furnace 1.

The area other than the measurement sample arrangement portion 12 and the reference sample arrangement portion 13 functions as the base portion 11.

The heat-sensitive member 10 is required to have an excellent thermal conductivity so that heat transferred from the heating furnace 1 is rapidly transferred to the measurement sample and the reference sample in the sample containers 3 and 4 arranged on the arrangement portions 12 and 13 respectively. In addition, it is required for the multi-pair thermocouples 21 and 22 described later to be capable of detecting the temperature difference between each of the arrangement portions 12, 13 and the base portion 11. Therefore, it is required that heat is transferred with a time difference required for temperature measurement, and from this point of view, it is required to suppress the thermal conductivity.

Furthermore, the heat-sensitive member 10 must have heat resistance to the extent that it is not deformed by heat from the heating furnace 1 and also is required to have electrical insulation properties to prevent short-circuiting of the multi-pair thermocouples 21 and 22.

Ceramic materials satisfy all the conditions described above, and particularly the heat-sensitive member 10 is formed of ceramic material called as mullite (3Al₂O₃·2SiO₂) in this embodiment. Mullite is a compound of aluminum oxide and silicon dioxide, and has excellent thermal conductivity, heat resistance and electrical insulation properties. In addition, mullite has a small linear expansion coefficient and thus little deformed (expanded) even when heated.

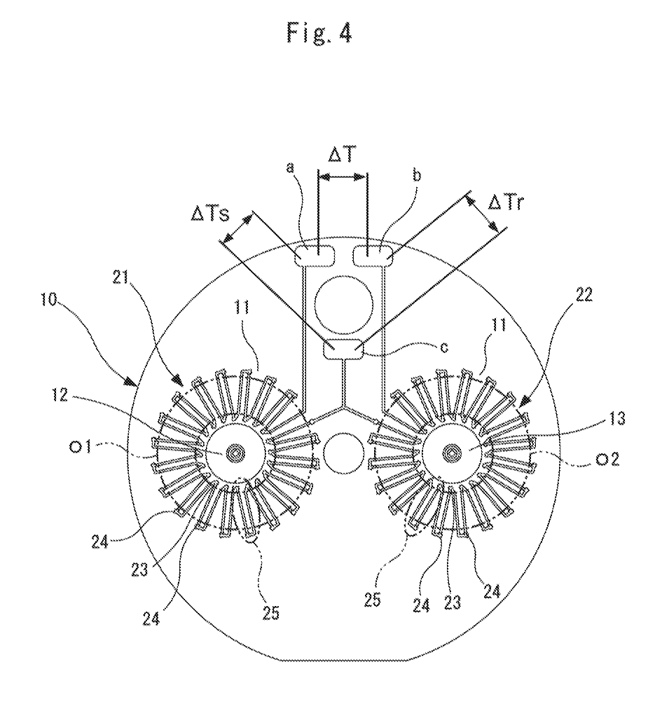

The first and second multi-pair thermocouples 21, 22 are thermocouples which are configured so that two kinds of different metal materials are alternately joined to one another, and plural temperature measurement contact points 23 and plural reference contact points 24 are alternately formed at the joint portions (junction portions) of the different metal materials as shown in FIG. 4. The multi-pair thermocouples 21, 22 are also configured so that plural thermocouple elements 25 are connected to one another in series, and the sum of electromotive forces each of which is output from each thermocouple according to the temperature difference between the temperature measurement contact point 23 and the reference contact point 24. Therefore, the multi-pair thermocouple has a feature that a large electromotive force is generated according to a small temperature difference, and thus the sensitivity of temperature measurement is enhanced.

In this embodiment, alloy of palladium (Pd) and gold (Au) and gold (Au) are used as the two kinds of different metal materials, and a thick film pattern of these metal materials is formed on the upper surface of the heat-sensitive member 10 by screen printing, thereby forming the first and second multi-pair thermocouples 21, 22.

With respect to the first multi-pair thermocouple 21, respective thermocouple elements 25 are radially arranged along a virtual circular ring O1 having the same center as the measurement sample arrangement portion 12, and the temperature measurement contact points 23 located inside the virtual circular ring O1 are arranged in the neighborhood of the measurement sample arrangement portion 12 (or in the measurement sample arrangement portion 12). On the other hand, the reference contact points 24 located outside the virtual circular ring O1 are arranged on the base portion 11. Both the ends of the first multi-pair thermocouple 21 are connected to terminal portions a and c.

The first multi-pair thermocouple 21 arranged on the upper surface of the heat-sensitive member 10 as described above outputs, to the terminal portions a and c, the electromotive force corresponding to the temperature difference ΔTs between the measurement sample arrangement portion 12 where the temperature measurement contact points 23 are arranged and the base portion 11 where the reference contact points 24 are arranged.

With respect to the second multi-pair thermocouple 22, respective thermocouple elements 25 are radially arranged along a virtual circular ring O2 having the same center as the reference sample arrangement portion 13, and the temperature measurement contact points 23 located inside the virtual circular ring O2 are arranged in the neighborhood of the reference sample arrangement portion 13 (or in the reference sample arrangement portion 13). On the other hand, the reference contact points 24 located outside the virtual circular ring O2 are arranged on the base portion 11. Both the ends of the second multi-pair thermocouple 22 are connected to terminal portions b and c.

The second multi-pair thermocouple 22 arranged on the upper surface of the heat-sensitive member 10 as described above outputs, to the terminal portions b and c, the electromotive force corresponding to the temperature difference ΔTr between the reference sample arrangement portion 13 where the temperature measurement contact points 23 are arranged and the base portion 11 where the reference contact points 24 are arranged.

Furthermore, one end portions of the first and second multi-pair thermocouples 21 and 22 are electrically joined to each other and connected to the terminal portion c. That is, the multi-pair thermocouples 21 and 22 are connected to each other in series. The electromotive force corresponding to the temperature difference ΔT between the measurement sample arrangement portion 12 and the reference sample arrangement portion 13 is output to the gap between the other terminal portions a and b.

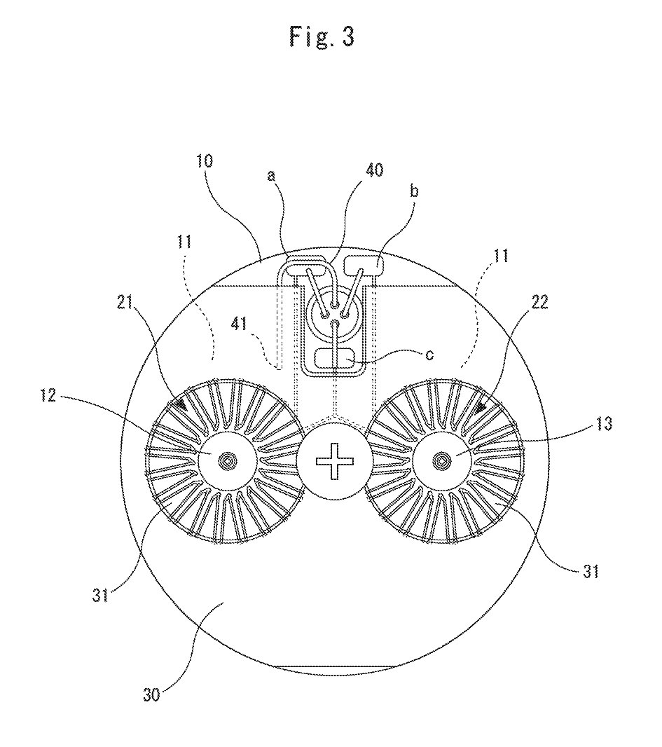

Furthermore, as shown in FIG. 3, a temperature measurement contact point 41 of a sheathed thermocouple 40 is joined to the base portion 11 of the heat-sensitive member 10. The sheathed thermocouple 40 constitutes base temperature measuring means for measuring the temperature of the base portion 11 of the heat-sensitive member 10.

As shown in FIG. 2, thermally uniformizing members 30 are adhesively attached to the upper surface (front surface) and bottom surface (back surface) of the heat-sensitive member 10. As shown in FIG. 3 each of the thermally uniformizing members 30 is formed like a disc in conformity with the outer shape of the heat-sensitive member 10, and circular cut-out holes 31 are formed in the measurement sample arrangement portion 12 and the reference sample arrangement portion 13 of the heat-sensitive member 10 and the formation areas of the first and second multi-pair thermocouples 21, 22 provided around the respective arrangement portions 12, 13 in the thermally uniformizing members 30 so that the thermally uniformizing members 30 are not in contact with these areas.

Here, the thermally uniformizing members 30 are arranged at the plural reference contact points 24 arranged on the base portion 11 of the heat-sensitive member 10 in the first and second multi-pair thermocouples 21, 22, and perform thermal uniformalization so that no temperature difference occurs among the reference contact point 24 (see FIG. 3).

These thermally uniformizing members 30 rapidly uniformalize heat transferred to the base portion 11 of the heat-sensitive member 10, and thus are preferably to have a higher thermal conductivity than the heat-sensitive member 10. Furthermore, as in the case of the heat-sensitive member 10, the thermally uniformizing member 30 must have such heat resistance that they are not deformed by heat from the heating furnace 1 and also are required to have electrical insulation properties in order to prevent short-circuiting of the multi-pair thermocouples 21, 22.

In addition, the thermally uniformizing members 30 which are adhesively attached to the heat-sensitive member 10 are required to have a linear expansion coefficient approximating the linear expansion coefficient of the heat-sensitive member 10 so that the thermal expansion thereof caused by heating is set to the same level as the heat-sensitive member 10 to prevent damage of each of the members 10, 30. As described above, when the difference in linear expansion coefficient between the attached members is limited to be within 1×10⁻⁶/° C., such an expansion difference as damages the members does not occur between the members even under heating at high temperature.

In this embodiment, the heat-sensitive member 10 is formed of mullite. However, a ceramic material which has a higher thermal conductivity than mullite and the same degree of linear expansion coefficient as mullite is a preferable material for the thermally uniformizing member 30. Therefore, in this embodiment, the thermally uniformizing member 30 is formed of aluminum nitride (AlN).

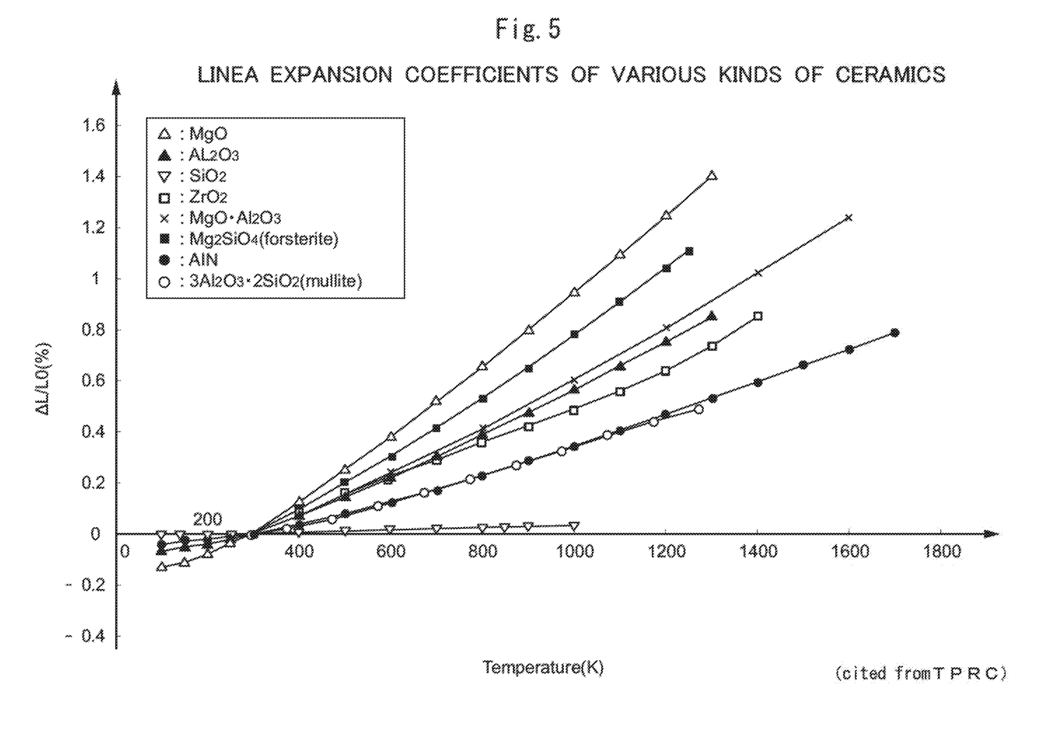

As shown in FIG. 5, aluminum nitride (AlN) is a ceramic material which has substantially the same linear expansion coefficient as mullite (3Al₂O₃·2SiO₂). In addition, aluminum nitride has a higher thermal conductivity than mullite and excellent heat resistance and electrical insulation properties, so that aluminum nitride satisfies all the conditions as a material applicable to the thermally uniformizing member 30.

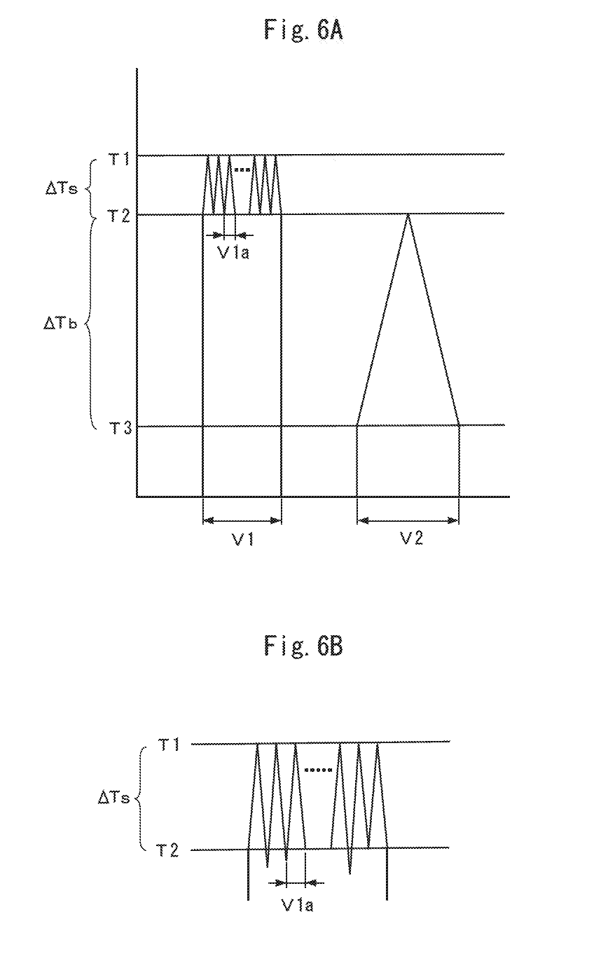

FIGS. 6A and 6B show a method of achieving sample temperature by the sensor unit configured as described above.

In FIG. 6A, the ordinate axis represents the temperature, and the abscissa axis represents the output (electromotive force) from the thermocouple. When V1 represents the output from the first multi-pair thermocouple 21 the magnitude of the output corresponds to the temperature difference ΔTs between the temperature T1 at the temperature measurement contact points 23 arranged in the neighborhood of the measurement sample arrangement portion 12 and the temperature T2 at the reference contact points 24 arranged on the base portion 11. The output V1 corresponds to the sum of the electromotive forces V1a occurring in the plural thermocouple elements 25 constituting the first multi-pair thermocouple 21. Here, the temperature difference ΔTs between the temperature T1 at the temperature measurement contact points 23 arranged in the neighborhood of the measurement sample arrangement portion 12 and the temperature T2 at the reference contact points 24 arranged on the base portion 11 is the temperature difference on the same heat-sensitive member 10, and thus it is very slight. Accordingly, the electromotive force V1a occurring in each individual thermocouple element 25 is small. The multi-pair thermocouples 21, 22 detects such a small temperature difference ΔTs as the sum of the small electromotive forces V1a occurring in the respective thermocouple elements 25, so that the small temperature difference ΔTs can be detected with remarkably higher sensitivity than a normal thermocouple.

According to thermal analysis equipment in which the sensor unit 2 according to the embodiment is installed, the temperature difference ΔTs between the temperature T1 at the temperature measurement contact points 23 arranged in the neighborhood of the measurement sample arrangement portion 12 and the temperature T2 at the reference contact points 24 arranged on the base portion 11 is detected on the basis of the output V1 from the first multi-pair thermocouple 21, and also the temperature difference ΔTb between the temperature T3 (for example, room temperature) at a place where the thermal analysis equipment is disposed and the temperature T2 of the base portion 11 of the heat-sensitive member 10 can be detected on the basis of an output (electromotive force) from the sheathed thermocouple 40. The temperature difference ΔTb detected on the basis of the output (electromotive force) from the sheathed thermocouple 40 is added with the temperature (for example, room temperature) 23 at the place where the thermal analysis equipment is set up, whereby the temperature T2 of the base portion 11 of the heat-sensitive member 10 can be determined. Furthermore, the temperature T2 of the base portion 11 of the heat-sensitive member 10 is added with the temperature difference ΔTs detected on the basis of the output V1 from the first multi-pair thermocouple 21, whereby the temperature T1 of the temperature measurement contact points 23 arranged in the neighborhood of the measurement sample arrangement portion 12 (that is, corresponding to the temperature of the sample in the measurement sample container 3) can be determined.

The thermal analysis equipment having the sensor unit 2 of this embodiment installed therein determines the temperature T2 of the base portion 11 of the heat-sensitive member 10 by using the sheathed thermocouple 40 as described above, and adds the temperature T2 of the base portion 11 with the temperature difference ΔTs detected on the basis of the output V1 from the first multi-pair thermocouple 21, thereby determining the temperature of the sample.

When there is any dispersion in temperature T2 among the plural reference contact points 24 arranged on the base portion 11 as enlarged in FIG. 6B, an error occurs in the output V1 from the first multi-pair thermocouple 21, and thus there is a risk that the temperature difference ΔTs between the measurement sample arrangement portion 12 and the base portion 11 cannot be accurately detected. However, according to the sensor unit 2 of this embodiment, the thermally uniformizing members 30 having a high thermal conductivity are adhesively attached to the base portion 11 of the heat-sensitive member 10, whereby the temperature of the base portion 11 of the heat-sensitive member 10 can be made thermally uniform through the thermally uniformizing members 30. Accordingly, dispersion of the electromotive forces occurring in the individual thermocouple elements 25 constituting the multi-pair thermocouples 21, 22 can be suppressed, and the temperature measurement precision can be enhanced.

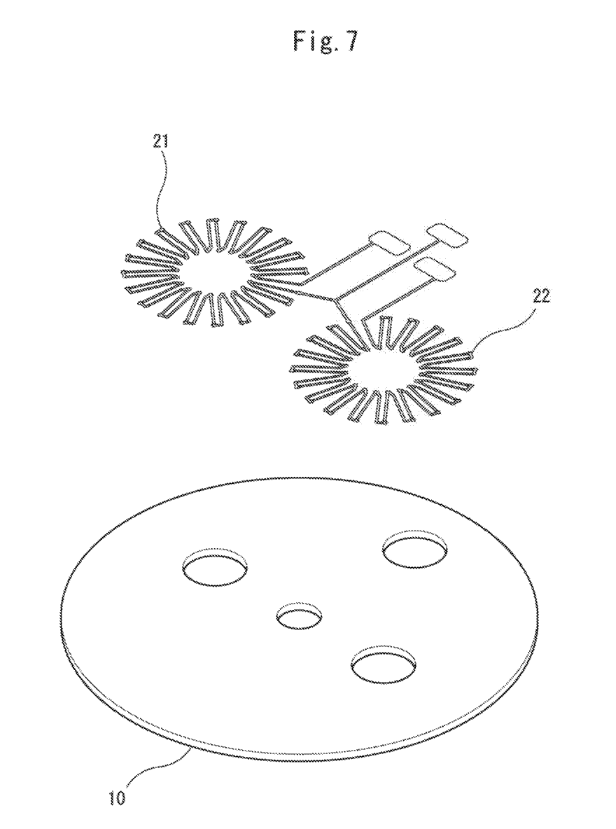

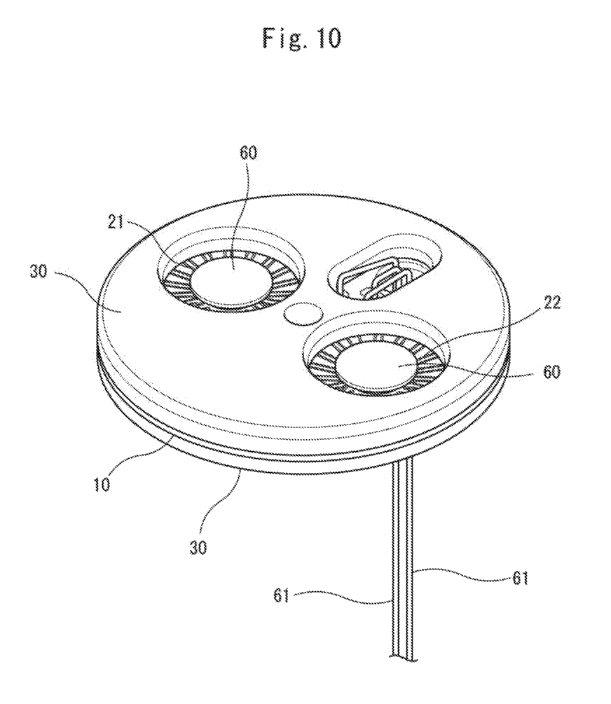

Next, a method of manufacturing the sensor unit according to the embodiment will be described with reference to FIGS. 7 to 10.

First, as shown in FIG. 7, thick film patterns of first and second multi-pair thermocouples 21, 22 are formed on the upper surface of the heat-sensitive member 10 formed of mullite by using two kinds of different metal materials (specifically, alloy of palladium (Pd) and gold (Au) and gold (Au)) according to the screen printing.

On paragraphs [0010] and [0011] of Patent Document 2 (WO2014/153438), it is indicated that the configuration of a thick film thermopile DSC sensor in which thermocouples are formed on a base material by the screen printing has the following disadvantage. That is, the thermocouple formed by the screen printing is spatially uneven because the thermocouple material is paste, and thus an error occurs as a thermocouple for measuring reference temperature. Furthermore, the thermocouple formed by the screen printing has higher impedance and thus causes noise because the paste thermocouple material has higher electrical resistance than solid alloy.

In consideration of these indications, aluminum nitride (AlN) is disposed as the thermally uniformizing member 30 on the outer periphery of each of the multi-pair thermocouples 21, 22, whereby the multi-pair thermocouples 21, 22 are thermally uniformalized and thus the average temperature can be measured. Furthermore, the electrical resistance can be reduced by using gold (Au) and alloy of gold (Au) as the thermocouple material. The electrical resistance can be also reduced by securing a sufficiently large film thickness or width for the thick film pattern forming each of the multi-pair thermocouples 21, 22. These countermeasures can reduce the electrical resistance of each of the multi-pair thermocouples 21, 22 to the level of several tens Ω, thereby implementing reduction of noises.

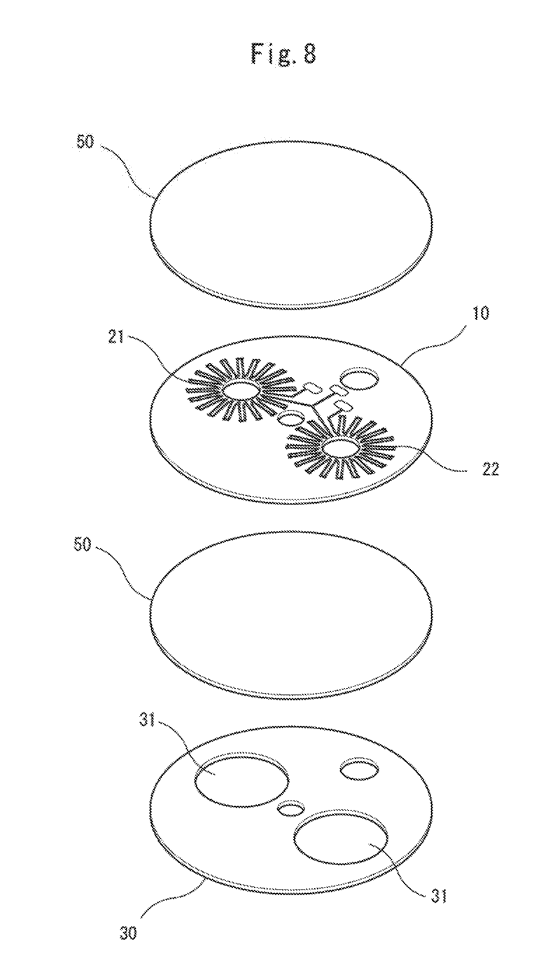

Subsequently, as shown in FIG. 8, glass paste 50 as adhesive agent is screen-printed on each of the upper surface of the heat-sensitive member 10 and the upper surface of the thermally uniformizing member 30 located at the lower side of the heat-sensitive member 10. The glass paste 50 used in this embodiment is adjusted to have substantially the same linear expansion coefficient as the heat-sensitive member 10 formed of mullite or the thermally uniformizing member 30 formed of aluminum nitride.

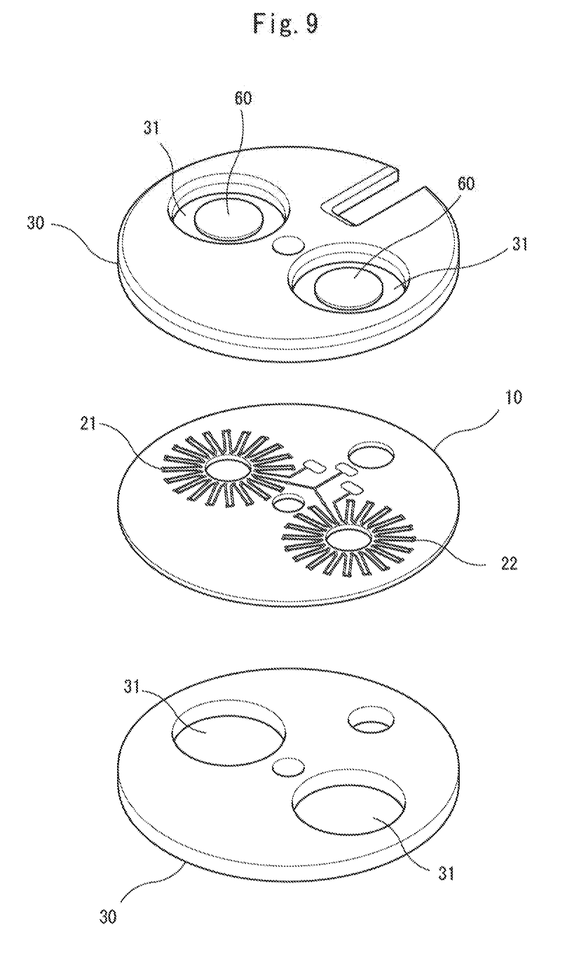

Subsequently, as shown in FIG. 9, the thermally uniformizing members 30 are superimposed on the upper surface and back surface of the heat-sensitive member 10 formed of mullite and then burned, whereby the thermally uniformizing members 30 are adhesively attached to the upper surface and back surface of the heat-sensitive member 10 by the glass paste 50. Furthermore, pads 60 formed of gold (Au) are adhesively attached to the surface of the measurement sample arrangement portion 12 and the surface of the reference sample arrangement portion 13 of the heat-sensitive member 10 by the glass paste 50 so that heat is rapidly transferred to the sample in the measurement sample container 3 and the reference sample in the reference sample container 4.

Thereafter, leading lines 61 formed of the same metal material (specifically, gold (Au)) as the first and second multi-pair thermocouples 21, 22 are connected to the terminal portions a, b and c provided to the heat-sensitive member 10, and the sheathed thermocouple 40 is connected to the base portion 11 of the heat-sensitive member 10, thereby completing the sensor unit 2.

The present invention is not limited to the embodiment and the example described above, and it is needless to say that various modifications and applications may be performed.

For example, the heat-sensitive member may be formed of ceramic materials other than mullite. Furthermore, the thermally uniformizing member may be formed of a ceramic material other than aluminum nitride insofar as the ceramic material is an heat-resistant and electrically insulating material which has a higher thermal conductivity than the heat-sensitive member and a linear expansion coefficient approximate to that of the heat-sensitive member.

The thermally uniformizing member may be adhesively attached to only one of the upper surface (front surface) and lower surface (back surface) of the heat-sensitive member as occasion demands.

Furthermore, base temperature measuring means for measuring the temperature of the base portion may be configured by a temperature sensor other than the sheathed thermocouple. Otherwise, the base temperature measuring means may be configured by a thermocouple formed by screen-printing a thick film pattern of two kinds of different metal materials on a heat-sensitive plate.

1. A sensor unit for thermal analysis equipment for detecting the temperature difference between a measurement sample and a reference sample, comprising:
a heat-sensitive member having a measurement sample arrangement portion where the measurement sample is disposed, a reference sample arrangement portion where the reference sample is disposed, and a base portion that is set to be located away from the measurement sample arrangement portion and the reference sample arrangement portion;
a first multi-pair thermocouple in which two kinds of different metal materials are alternately joined to one another to alternately form plural temperature measurement contact points and plural reference contact points so that the plural temperature measurement contact points are arranged at the measurement sample arrangement portion and the plural reference contact points are arranged at the base portion;
a second multi-pair thermocouple in which two kinds of different metal materials are alternately joined to one another to alternately form plural temperature measurement contact points and plural reference contact points so that the plural temperature measurement contact points are arranged at the reference sample arrangement portion and the plural reference contact points are arranged at the base portion; and
a thermally uniformizing member that is adhesively attached to the base portion, wherein the thermally uniformizing member is formed of a heat-resistant and electrically insulating material that has a higher thermal conductivity than the heat-sensitive member and a linear expansion coefficient approximate to that of the heat-sensitive member.

2. The sensor unit for thermal analysis equipment according to claim 1, wherein the thermally uniformizing member is formed of a heat-resistant and electrically insulating material having a linear expansion coefficient which is different from the linear expansion coefficient of the heat-sensitive member within 1×10⁻⁶/° C.

3. The sensor unit for thermal analysis equipment according to claim 1, wherein the heat-sensitive member is formed of mullite, and the thermally uniformizing member is formed of aluminum nitride.

4. The sensor unit for thermal analysis equipment according to claim 1, further comprising base temperature measuring means for measuring the temperature of the base portion.

5. The sensor unit for thermal analysis equipment according to claim 4, wherein the base temperature measuring means comprises a sheathed thermocouple.

6. The sensor unit for thermal analysis equipment according to claim 1, wherein the heat-sensitive member is configured like a flat plate, the first and second multi-pair thermocouples are screen-printed on the heat-sensitive member, and the thermally uniformizing member is configured like a flat plate and adhesively attached to the heat-sensitive member through glass paste.

7. The sensor unit for thermal analysis equipment according to claim 6, wherein the thermally uniformizing member is adhesively attached to each of the front surface and back surface of the heat-sensitive member.

8. A sensor unit for thermal analysis equipment for detecting the temperature difference between a measurement sample and a reference sample, comprising:
a heat-sensitive member that has a measurement sample arrangement portion where the measurement sample is disposed, a reference sample arrangement portion where the reference sample is disposed, and a base portion that is set to be located away from the measurement sample arrangement portion and the reference sample arrangement portion, and is formed of mullite;
a first multi-pair thermocouple in which two kinds of different metal materials are alternately joined to one another to alternately form plural temperature measurement contact points and plural reference contact points so that the plural temperature measurement contact points are arranged at the measurement sample arrangement portion and the plural reference contact points are arranged at the base portion;
a second multi-pair thermocouple in which two kinds of different metal materials are alternately joined to one another to alternately form plural temperature measurement contact points and plural reference contact points so that the plural temperature measurement contact points are arranged at the reference sample arrangement portion and the plural reference contact points are arranged at the base portion;
a thermally uniformizing member that is formed of aluminum nitride and adhesively attached to the base portion ; and
a sheathed thermocouple for measuring the temperature of the base portion, wherein the heat-sensitive member is configured like a flat plate, the first and second multi-pair thermocouples are screen-printed on the heat-sensitive member, and the thermally uniformizing member is configured like a flat plate and adhesively attached to each of the front surface and back surface of the heat-sensitive member through glass paste.

9. Thermal analysis equipment comprising:
a heating furnace; and
a temperature measuring unit provided in the heating furnace wherein the sensor unit according to claim 1 is installed in the temperature measuring unit.

10. Thermal analysis equipment comprising:
a heating furnace; and
a temperature measuring unit provided in the heating furnace, wherein the sensor unit according to claim 8 is installed in the temperature measuring unit.
